(19) United States
(12) Patent Application Publication
(10) Pub. No.: US 2015/0012259 A1
(43) Pub. Date: Jan. 8, 2015

(54) LANGUAGE TRANSLATOR MODULE IN THE MIDDLEWARE TOOL PROCESS INTEGRATION

(71) Applicants: Vikas Gupta, Jaipur (IN); Aby Jose, Kerala (IN); Mamatha K H, Bangalore (IN)

(72) Inventors: Vikas Gupta, Jaipur (IN); Aby Jose, Kerala (IN); Mamatha K H, Bangalore (IN)

(73) Assignee: SAP AG, Walldorf (DE)

(21) Appl. No.: 13/934,124

(22) Filed: Jul. 2, 2013

(51) Int. Cl. G06F 17/28

(52) U.S. Cl. CPC G06F 17/289
USPC 704/2

(57) ABSTRACT

A process integration system to interface between a sender system and a receiver system is described. The process integration system has a sender adapter, an integration engine, a receiver adapter, and a language converter module. The sender adapter receives a communication in a first language from the sender system. The communication is in a first format of the sender system. The sender adapter converts the communication into a second format of the process integration system, and the integration engine identifies the receiver system from the communication in the second format. The receiver adapter converts the communication from the second format to a third format of the receiver system, and sends the communication in the third format and in a second language to the receiver system. The language converter module translates the communication in the third format to the second language associated with the receiver system.

### FIELD

The present disclosure relates generally to a language translation module, and in a specific example embodiment, to a language translation module in a middleware tool.

### BACKGROUND

Multinational enterprises interact with different vendors and customers across the world. For example, those interactions may include daily, weekly, and monthly reports among different parties in different languages among different countries.

In another example, a company may have offices across the world with sales people from different language background to interact with local vendors. These sales people may generate reports that are sent back to a corporate headquarter in another country using a different language.

In the above example, emails are received in the same language they are sent. Mail servers typically send the message in the same language. Typical language translation application provides an additional layer to the interaction between parties with different languages because a party needs to manually identify the source language and convert the message from the source language to a target language.

### BRIEF DESCRIPTION OF DRAWINGS

The appended drawings merely illustrate example embodiments of the present invention and cannot be considered as limiting its scope.

FIG. 1 is a block diagram illustrating an example of a system in which embodiments may be practiced;

FIG. 2 is a block diagram illustrating another example of a system in which embodiments may be practiced;

FIG. 3 is a ladder diagram, in accordance with an example embodiment, illustrating an operation of the system of FIG. 2;

FIG. 4 is a ladder diagram, in accordance with another example embodiment, illustrating an operation of the system of FIG. 2;

FIG. 5 is a ladder diagram, in accordance with another example embodiment, illustrating an operation of the system of FIG. 2;

FIG. 6 is a flowchart of a method, in accordance with an example embodiment, for operating a process integration system;

FIG. 7 is a flowchart of a method, in accordance with another example embodiment, for operating a process integration system;

FIG. 8 is a flowchart of a method, in accordance with another example embodiment, for operating a process integration system; and

FIG. 9 is a block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments. It will be evident, however, to those skilled in the art that embodiments of the inventive subject matter may be practiced without these specific details. In general, well-known instruction instances, protocols, structures, and techniques have not been shown in detail.

Example systems and methods for a process integration system to interface between a sender system and a receiver system are described. The process integration system has a sender adapter, an integration engine, a receiver adapter, and a language converter module. The sender adapter receives a communication in a first language from the sender system. The communication is in a first format of the sender system. The sender adapter converts the communication into a second format of the process integration system, and the integration engine identifies the receiver system from the communication in the second format. The receiver adapter converts the communication from the second format to a third format of the receiver system, and sends the communication in the third format and in a second language to the receiver system. The language converter module translates the communication in the third format to the second language associated with the receiver system. The third format is a format that is capable of being used by the receiver system.

In an example embodiment, a language identification module identifies the first language associated with the sender system, and the second language associated with the receiver system. A translation engine translates a content of the communication from the first language to the second language and replaces the content of the communication with the translated content in the second language.

In another example embodiment, the sender adapter receives a second communication in a third language from a second sender system. The second communication is in a fourth format of the second sender system. The fourth format is a format that is capable of being used by the second sender system. The sender adapter converts the second communication into the second format of the process integration system, and the integration engine identifies the receiver system from the second communication in the second format. The receiver adapter converts the second communication from the second format to the third format of the receiver system and sends the second communication in the second language and in the third format to the receiver system. The language converter module translates the second communication in the third format to the second language associated with the receiver system.

In another example embodiment, the integration engine identifies a second receiver system from the communication in the second format. The receiver adapter converts the communication from the second format to a fourth format of the second receiver system, and sends the communication in the fourth format and in a third language to the second receiver system. The language converter module translates the communication in the fourth format to the third language associated with the second receiver system.

In another example embodiment, the sender adapter receives a first message from a sender at the sender system. The language converter module accesses the identified language of a recipient of the first message and generates a second message in the identified language of the recipient.

In another example embodiment, the process integration system interfaces between heterogeneous systems to provide a unified interface. The heterogeneous systems include the sender system and the receiver system. The sender system or the receiver system comprises a file server, a mail server, or a database server. The second format comprises an XML-based format.

In another example embodiment, the sender adapter receives a second communication in a third language from the sender system. The second communication is in the first format of the sender system. The sender adapter converts the second communication into the second format of the process integration system, and the integration engine identifies the receiver system from the second communication in the second format. The receiver adapter converts the second communication from the second format to the third format of the receiver system and sends the second communication in the second language and in the third format to the receiver system. The language converter module translates the second communication in the third format to the second language associated with the receiver system.

In another example embodiment, the sender adapter receives a second communication in the first language from the sender system. The second communication is in the first format of the sender system. The sender adapter converts the second communication into the second format of the process integration system, and the integration engine identifies the receiver system from the second communication in the second format. The receiver adapter converts the second communication from the second format to the third format of the receiver system, and sends the communication in the third format and in a third language to the receiver system. The language converter module translates the second communication in the third format to the third language associated with the receiver system.

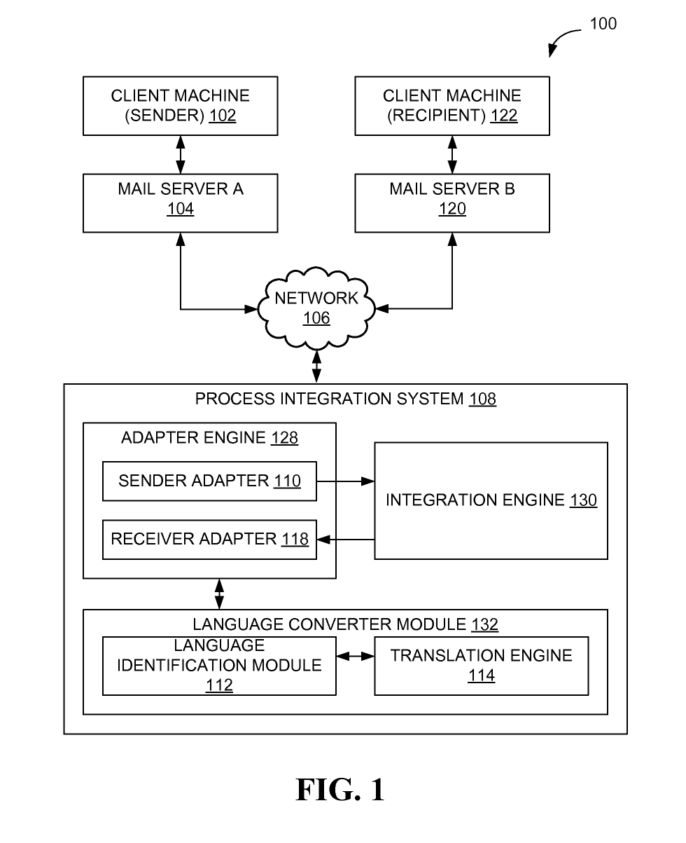

FIG. 1 is a block diagram depicting an example environment 100 within which example embodiments may be deployed. The environment 100 may include one or more client machines (e.g., client machine 102, 122). For example, the client machines 102, 122 may be a personal computer, or a mobile computing device configured to generate communication messages such as emails.

In one embodiment, the client machines 102, 122 may be used to access email, contact, and calendar information from a corresponding mail server, such mail server A 104 and mail server B 120. The client machines 102, 122 may execute a web browser (not shown) or a software application (not shown). For example, the web browser may be any browser commonly used to access a network of computers such as the World Wide Web. The web browser may load a user interface to access emails, contact, and calendar information from the mail servers 104, 120. In another embodiment, access may be performed by the mail servers 104, 120 where data retrieved from external systems is then stored on the mail servers 104, 120 and the client machines 102, 122 can request this data.

The web browser may also be used to generate a communication, such as an email to a recipient as part of an email program from the mail servers 104, 120. In another embodiment, the software application may load a user interface to access emails, contact, and calendar information from the mail servers 104, 122. In other words, the software application may include a dedicated communication application for an operating system of the client machines 102, 122. The software application may thus include an email client configured to access a corresponding mail server.

The mail servers 104, 120 may be configured to provide the functionalities of a mail server such as, for example, a Simple Mail Transfer Protocol (SMTP) mail server. In other words, the mail servers 104, 120 handle electronic message sent and received via a network of computers such as the Internet. A mail server also referred to as mail host or mail exchanger transfers electronic mail messages from one computer to another using a client-server application architecture. A message transfer agent (MTA) receives mail from either another message transfer agent, a mail submission agent (MSA), or a mail user agent (MUA). The transmission details are specified by the Simple Mail Transfer Protocol (SMTP) or Internet Message Access Protocol (IMAP). When a recipient mailbox of a message is not hosted locally, the message is relayed, that is, forwarded to another MTA. Every time an MTA receives an email message, it adds a “Received” trace header field to the top of the header of the message, thereby building a sequential record of MTAs handling the message. The process of choosing a target MTA for the next hop is also described in SMTP.

An active directory (not shown) in the mail servers 104, 120 may be configured to provide the functionalities of a directory server such as, for example, a Lightweight Directory Access Protocol (LDAP) server. LDAP is an application protocol for accessing and maintaining distributed directory information services over an Internet Protocol (IP) network. Directory services may provide any organized set of records, often with a hierarchical structure, such as a corporate email directory. Similarly, a telephone directory is a list of subscribers with an address and a phone number. In one embodiment, the LDAP may be specific to the company and provide a directory information service for employees of the organization.

Thus, mail servers 104, 122 may include a message transfer agent or mail relay responsible for receiving, routing, and delivering email messages. Mail server A 104 may communicate through a network 106 with mail server B 120. In one embodiment, mail server A 104 interfaces with mails server B 120 via a process integration system 108.

In one example embodiment, the process integration system 108 includes, for example, an adapter engine 128, an integration engine 130, and a language converter module 132. The process integration system 108 interfaces between mail server A 104 and mail server B 120 and provides a unified interface for both heterogeneous systems (e.g., mail server A 104 uses native formats and protocols that are different from mail server B 120). In other words, mail server A 104 can send messages in its own native format and mail server B 120 receives the message in mail server B's format.

In one example embodiment, the adapter engine 128 includes a sender adapter 110 and a receiver adapter 118. The sender adapter 110 receives the messages from the mail server A 104 and converts the messages into the format which the integration engine 130 can understand (e.g., XML format). The integration engine 130 receives the converted messages (e.g., messages in XML format) from the sender adapter 110 and identifies the mail server B 120 as the receiver. The receiver adapter 118 receives the converted messages (e.g., message in XML format) from the integration engine 130 and converts the messages in the format of mail server B 120.

The receiver adapter 118 may include data identifying the language in which the message is to be translated. For example, the receiver adapter 118 may store a parameter value that identifies the language associated with a particular receiver system in one instance of communication between sender and receiver.

In another example embodiment, the processing integration system 108 may include multiple instances of the sender adapter 110 and the receiver adapter 118 to support multiple communication channels between sender systems and receiver systems.

The language converter module 132 includes a language identification module 112, and a translation engine 114. The language identification module 112 identifies the language associated with the mail server A 104 (e.g., English) and the language associated with the mail server B 120 (e.g., German). The translation engine 114 translates a content of the communication from the identified language of mail server A 104 (e.g., English) to the identified language of mail server B 120 (e.g., German).

The sender adapter 110 may receive a message from the mail server 104 or the client machine 102. The message may include an email addressed to a recipient at client machine 122. The recipient's email address may be associated with a different mail server, such as mail server B 120.

The translation engine 114 translates a content of the message in the identified language of the recipient, and replaces the content of the message with the translated content to generate a translated message. For example, the content of the message may be in Chinese. The receiver adapter 118 may determine that the identified language of the recipient is German. The translation engine 114 translates the content of the message from Chinese to German. The translation engine 114 may then replace the Chinese version in the message with the German version and generate the translated message.

The receiver adapter 118 may then send the translated message to the mail server 120 associated with the recipient.

In another example embodiment, the language identification module 112 identifies a language of the content in the message from mail server A 104. The language identification module 112 determines an identity of the recipient of the message. For example, the message may be addressed to john@example1.com. As such, the language identification module 112 identifies the mail server associated with “example1.com” to determine the preferred language associated with “john@example1.com”. The mail server 120 may store a preference identifying one or more preferred languages associated with the email “john@example1.com.”

In another example embodiment, the sender adapter 110 receives a reply message from the mail server B 120 in response to the message from client mail server A 104. The translation engine 114 translates a content of the reply message from the preferred language (e.g., German in the previous example) to the language of the content of the original message from the mail server B 104 (e.g., Chinese). For example, the translation engine 114 may directly translate the reply message without having to identify a preferred language of the user who sent the original email via the mail server A 104. The translation engine 114 then replaces the content of the reply message with the translated content of the reply message to generate a reply translated message from mail server B 120. In this example embodiment, the receiver adapter 118 sends the translated reply message back to the mail server A 104 associated with the original sender.

In another example embodiment, the sender adapter 110 identifies an identity of a sender of the message and an identity of a recipient of the message. For example, the sender adapter 110 may determine from the body of the email that the sender is jane@example2.com and that the recipient is john@example1.com. The language identification module 112 may identify a language of the content of the message based on the identity of the sender. For example, jane@example2.com's preferred language may be Chinese. In another example embodiment, the language identification module 112 may scan the body of the message to determine a language associated with the message. The translation engine 114 translates the content of the message from the language of the sender (e.g., Chinese) to the preferred language of the recipient (e.g., German).

The client machines 102, 122, the mail servers 104, 120, and the process integration system 108 may be coupled to each other via a network 106. The network 106 enables communication between systems. Accordingly, the network 106 may be a mobile telephone network, a Plain Old Telephone (POTS) network, a wired network, a wireless network (e.g., a WiFi or WiMax network), or any suitable combination thereof. The communication may be based on any communication protocols. Examples of communication protocols include Transmission Control Protocol/Internet Protocol (TCP/IP), HyperText Transfer Protocol (HTTP), File Transfer Protocol (FTP), Simple Mail Transfer Protocol (SMTP), Post Office Protocol (POP), Internet Message Access Protocol (IMAP), Wireless Access Protocol (WAP), Gopher, wireless internet protocols, and instant messaging protocols. The network 106 may be implemented using the Internet, a wide area network (WAN), a local area network (LAN), or any suitable combination thereof.

Those of ordinary skills in the art will recognize that the systems illustrated in FIG. 1 may be configured using other variations where a module or application, such as the mail server A 104, the mail server B 120, or the process integration system 108 may reside in a different or in the same machine.

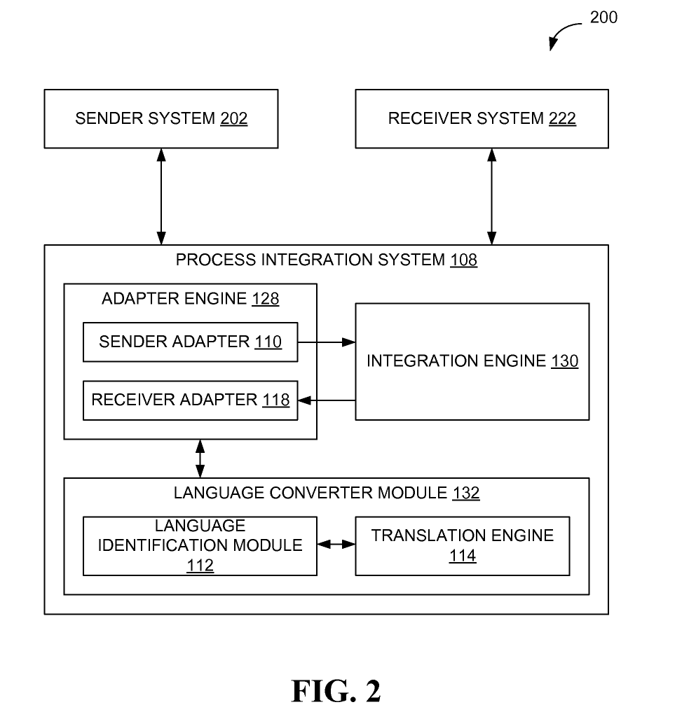

FIG. 2 is a block diagram illustrating another example of a system 200 in which embodiments may be practiced. A sender system 202 communicates with a receiver system 222 via a process integration system 108. The sender system 200 and the receiver system 222 may include heterogeneous systems. For example, the sender system 200 operates with a format different from the format of the receiver system 222. The sender system 200 and the receiver system 200 may include, for example, a file server, a mail server, a web service, or a database server. The sender system 200 and the receiver system 200 may be of the same or different type of system (e.g., file server to file server, or mail server to file server).

As such, the process integration system 108 provides a unified interface view of data and information through a process of information integration using data abstraction to provide a unified interface (or uniform data access) for viewing all the data using a single set of structures and naming conventions to represent the data.

The process integration system 108 includes the adapter engine 128, the integration engine 130, and the language converter module 132. As previously described, the adapter engine 128 interfaces between the sender system 202 and the receiver system 222 to provide uniform data access. The adapter engine 128 may include the sender adapter 110, and the receiver adapter 118. The sender adapter 118 receives a communication in a first language (e.g., English) from the sender system 202. The communication is in a first format (e.g., mail, Java Database Connectivity (JDBC), Intermediate Document (IDCO), Java Message Service (JMS), or Simple Object Access Protocol (SOAP)) of the sender system 202. The integration engine 130 converts the communication into a second format (e.g., XML) of the process integration system 108, and identifies the receiver system 222 from the communication in the second format (e.g., XML). The receiver adapter 118 converts the communication from the second format (e.g., XML) to a third format (e.g., of the receiver system 222), and sends the communication in the third format and in a second language (e.g., German) to the receiver system 222. The third format may also include for example, mail, Java Database Connectivity (JDBC), Intermediate Document (IDCO), Java Message Service (JMS), or Simple Object Access Protocol (SOAP)). In one example, both first and third formats are the same. In another example, both first and third formats are different. The language converter module 132 translates the communication in the third format (e.g., mail, Java Database Connectivity (JDBC), Intermediate Document (IDCO), Java Message Service (JMS), or Simple Object Access Protocol (SOAP)) to the second language (e.g., German) associated with the receiver system 222.

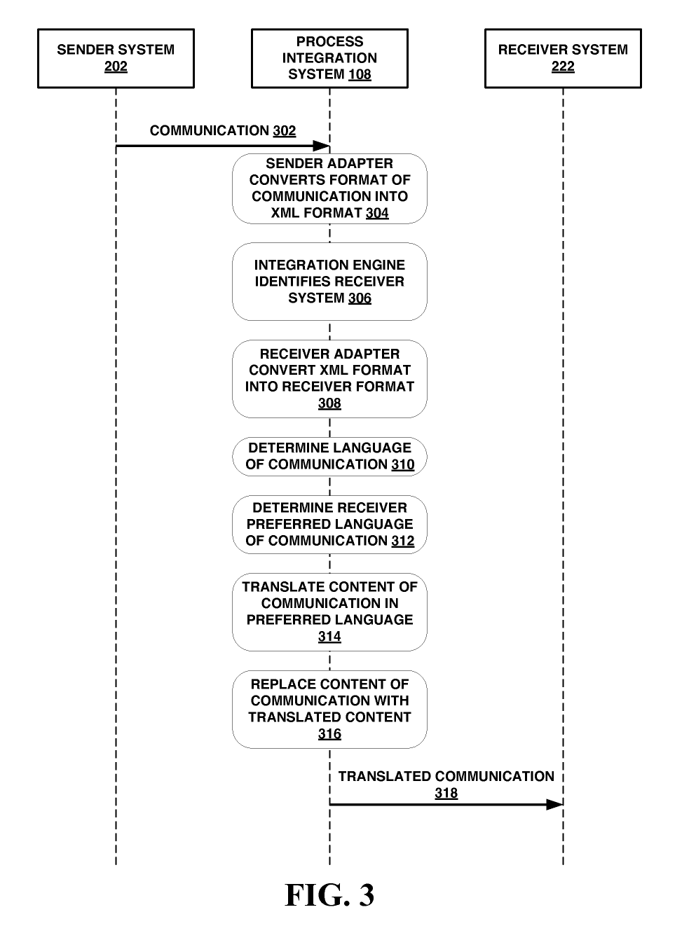

FIG. 3 is a ladder diagram, in accordance with an example embodiment, illustrating an operation of the system of FIG. 2. At operation 302, the sender system 202 generates a communication to the receiver system 222 via the process integration system 108. At operation 304, the sender adapter 110 of the process integration system 108 converts a format of the communication into XML format. At operation 306, the integration engine 130 of the process integration system 108 identifies the receiver system 222. At operation 308, the receiver adapter 118 of the process integration system 108 converts the XML format into a format understood by the receiver system 222. At operation 310, the language identification module 112 determines the language of the communication received from the sender system 202. At operation 312, the language identification module 112 determines a preferred language of the receiver system 222. At operation 314, the translation engine 114 translates a content of the communication in the preferred language of the receiver system 222. At operation 316, the translation engine 114 replaces a content of the communication with the translated content. At operation 318, the receiver adapter 118 sends the translated communication in the format of the receiver system 222.

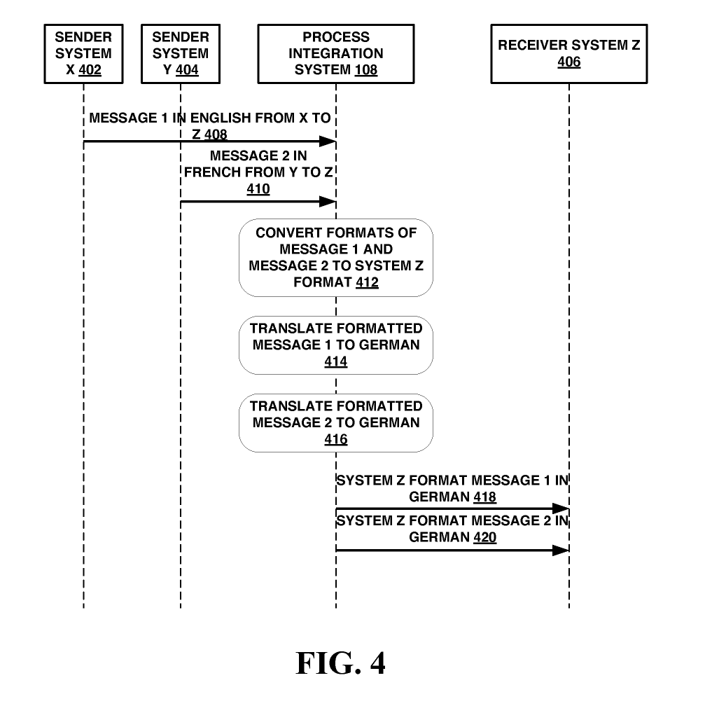

FIG. 4 is a ladder diagram, in accordance with another example embodiment, illustrating an operation of the system of FIG. 2. At operation 408, a sender system X 402 sends a first message in English to a receiver system Z 406. At operation 410, a sender system Y 404 sends a second message in French to the receiver system Z 406. The process integration system 108 intercepts both messages. At operation 412, the sender adapter 110 converts the format of the first message and the format of the second message into a format compatible with the receiver system Z 406. The process integration system 108 identifies that the receiver system Z 406 is associated with the German language. At operations 414 and 416, the translation engine 114 translates the formatted first and second messages to German. At operation 418, the receiver adapter 118 sends the first message in receiver system Z format and in German to the receiver system Z 406. At operation 420, the receiver adapter 118 sends the second message in receiver system Z format and in German to the receiver system Z 406.

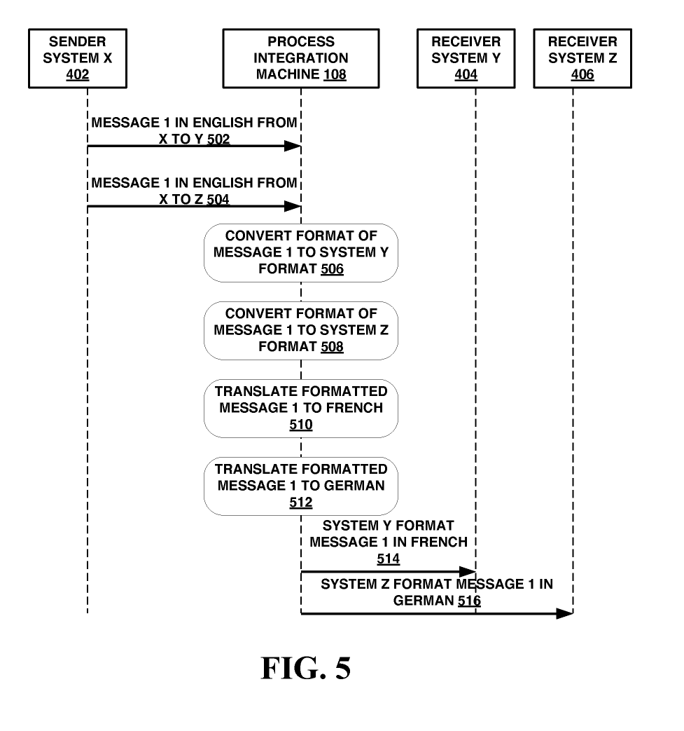

FIG. 5 is a ladder diagram, in accordance with another example embodiment, illustrating an operation of the system of FIG. 2. At operation 602, sender system X 402 sends a first message in English to receiver system Y 404. At operation 604, sender system X 402 also sends the first message in English to receiver system Z 406. At operation 606, the sender adapter 110 converts a format of the first message to a format compatible with the receiver system Y 404. At operation 608, the sender adapter 110 converts a format of the first message to a format compatible with the receiver system Z 406. At operation 610, the translation engine 114 translates the formatted first message to French. At operation 612, the translation engine 114 translates the formatted first message to German. At operation 614, the receiver adapter 118 sends the first message in a format compatible with the receiver system Y 404 to the receiver system Y 404. At operation 616, the receiver adapter 118 sends the first message in a format compatible with the receiver system Z 406 to the receiver system Z 406.

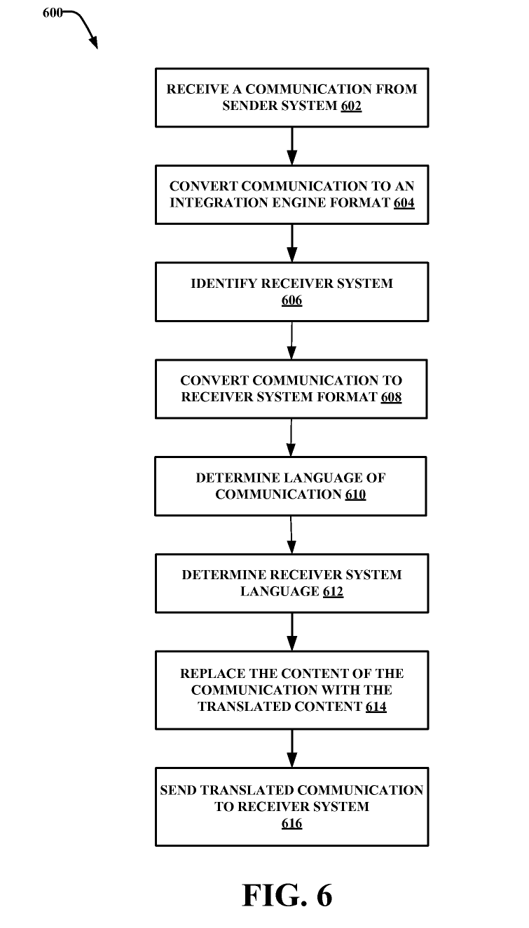

FIG. 6 is a flowchart of a method 600, in accordance with an example embodiment, for operating a process integration system. At operation 602, a communication is received from a sender system. In one embodiment, the sender adapter 110 of the process integration system 108 of FIG. 2 performs this operation.

At operation 604, the communication is converted to a format associated with the integration engine 130. In one embodiment, the sender adapter 110 of the process integration system 108 of FIG. 2 performs this operation.

At operation 606, a receiver system associated with the communication is identified. In one embodiment, the integration engine 130 of the process integration system 108 of FIG. 2 performs this operation.

At operation 608, a format of the communication is converted to a format associated with the receiver system. In one embodiment, the receiver adapter 118 of the adapter engine 128 of FIG. 2 performs this operation.

At operation 610, a language of the communication is determined. In one embodiment, the language identification module 112 of the language converter module 132 of FIG. 2 performs this operation.

At operation 612, a language associated with the receiver system is determined. In one embodiment, the language identification module 112 of the language converter module 132 of FIG. 2 performs this operation.

At operation 614, the content of the communication is replaced with a translated content in the language associated with the receiver system. In one embodiment, the translation engine 114 of the language converter module 132 of FIG. 2 performs this operation.

At operation 616, the translated communication is sent to the receiver system 222. In one embodiment, the receiver adapter 118 of the adapter engine 128 of FIG. 2 performs this operation.

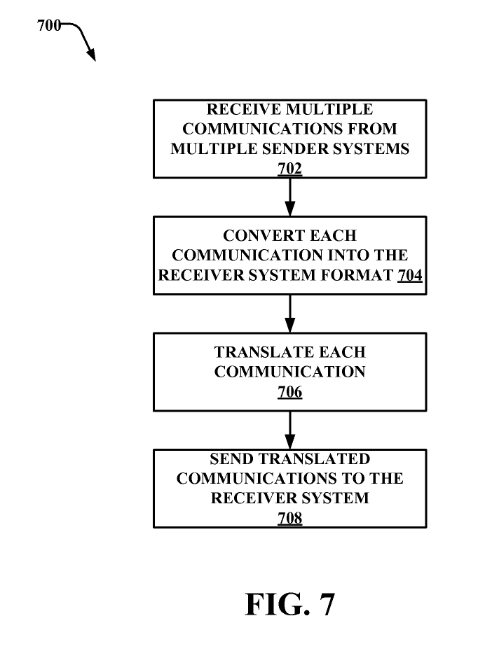

FIG. 7 is a flowchart of a method 700, in accordance with another example embodiment, for operating a process integration system. At operation 702, multiple communications from multiple sender systems are received. In one embodiment, the sender adapter 110 of the adapter engine 128 of FIG. 2 performs this operation.

At operation 704, each communication is converted into the format associated with the receiver system. In one embodiment, the integration engine 130 of the process integration system 108 of FIG. 2 performs this operation.

At operation 706, each formatted communication is translated. In one embodiment, the translation engine 114 of the language converter module 132 of FIG. 2 performs this operation.

At operation 708, the translated communications are sent to the receiver system. In one embodiment, the receiver adapter 118 of the adapter engine 128 of FIG. 2 performs this operation.

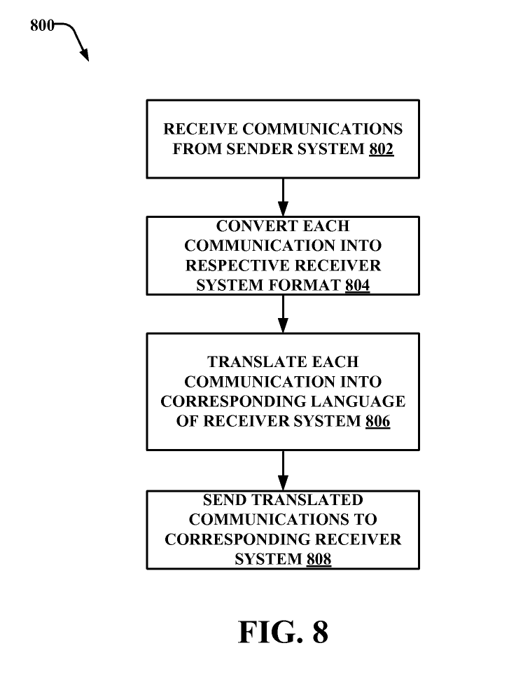

FIG. 8 is a flowchart of a method 800, in accordance with another example embodiment, for operating a process integration system. At operation 802, communications for several receiver systems are received from a sender system. In one embodiment, the sender adapter 110 of the adapter engine 128 of FIG. 2 performs this operation.

At operation 804, each communication is converted into a respective format associated with receiver systems. In one embodiment, the receiver adapter 118 of the adapter engine 118 of FIG. 2 performs this operation.

At operation 806, each communication is translated into its corresponding language associated with the receiver system. In one embodiment, the translation engine 114 of the language converter module 132 of FIG. 2 performs this operation.

At operation 808, the translated communications are sent to the corresponding receiver systems. In one embodiment, the receiver adapter 118 of the adapter engine 128 of FIG. 2 performs this operation.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

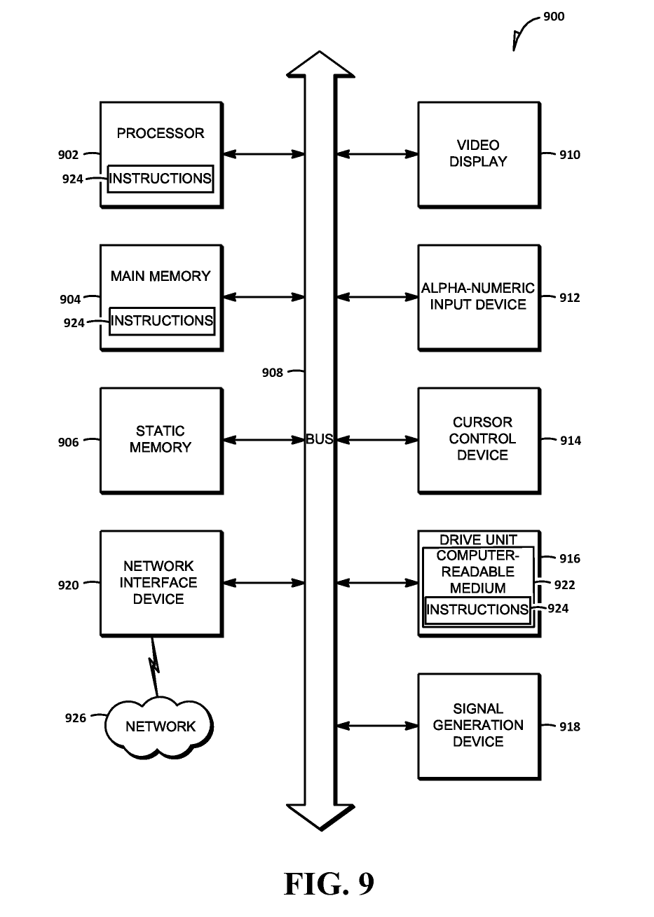

FIG. 9 is a block diagram of a machine in the example form of a computer system 900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation (or cursor control) device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. The instructions 924 may also reside, completely or at least partially, within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving a communication in a first language from a sender system, the communication in a first format of the sender system;
converting, using at least one processor of a machine, the communication into a second format of a process integration system, the process integration system configured to interface between the sender system and a receiver system;
identifying the receiver system from the communication in the second format;
converting the communication from the second format to a third format of the receiver system;
translating the communication in the third format to a second language associated with the receiver system; and
sending the communication in the third format and in the second language to the receiver system.

2. The method of claim 1, wherein the translating further comprises:
determining the first language associated with the sender system;
determining the second language associated with the receiver system;
translating a content of the communication from the first language to the second language; and
replacing the content of the communication with the translated content in the second language.

3. The method of claim 1, further comprising:
receiving a second communication in a third language from a second sender system, the second communication in a fourth format of the second sender system;
converting the second communication into the second format of the process integration system;
identifying the receiver system from the second communication in the second format;
converting the second communication from the second format to the third format of the receiver system;
translating the second communication in the third format to the second language associated with the receiver system; and
sending the second communication in the second language and in the third format to the receiver system.

4. The method of claim 1, further comprising:
identifying a second receiver system from the communication in the second format;
converting the communication from the second format to a fourth format of the second receiver system;
translating the communication in the fourth format to a third language associated with the second receiver system; and
sending the communication in the fourth format and in the third language to the second receiver system.

5. The method of claim 4, further comprising:
receiving a first message from a sender at the sender system;
accessing the identified language of a recipient of the first message at the process integration system; and
generating a second message in the identified language of the recipient at the process integration system.

6. The method of claim 1, wherein the process integration system interfaces between heterogeneous systems to provide a unified interface, the heterogeneous systems comprising the sender system and the receiver system.

7. The method of claim 1, wherein the sender system or the receiver system comprises a file server, a mail server, or a database server, wherein the second format comprises an XML-based format.

8. The method of claim 1, further comprising:
receiving a second communication in a third language from the sender system, the second communication in the first format of the sender system;
converting the second communication into the second format of the process integration system;
identifying the receiver system from the second communication in the second format;
converting the second communication from the second format to the third format of the receiver system;
translating the second communication in the third format to the second language associated with the receiver system; and
sending the second communication in the second language and in the third format to the receiver system.

9. The method of claim 1, further comprising:
receiving a second communication in the first language from the sender system, the second communication in the first format of the sender system;
converting the second communication into the second format of the process integration system;
identifying the receiver system from the second communication in the second format;
converting the second communication from the second format to the third format of the receiver system;
translating the second communication in the third format to a third language associated with the receiver system; and
sending the communication in the third format and in the third language to the receiver system.

10. A process integration system comprising:
a processor having an adapter engine, an integration engine, and a language converter module,
the adapter engine configured to interface between a sender system and a receiver system, the adapter engine comprising:
a sender adapter configured to receive a communication in a first language from the sender system, the communication in a first format of the sender system; and
a receiver adapter configured to convert the communication from a second format to a third format of the receiver system, and send the communication in the third format and in a second language to the receiver system,
the integration engine configured to convert the communication from the first format of the sender system into a second format of the process integration system, and to identify the receiver system from the communication in the second format, and
the language converter module configured to translate the communication in the third format to the second language associated with the receiver system.

11. The process integration system of claim 10, wherein the language converter module comprises:
a language identification module configured to identify the first language associated with the sender system, and the second language associated with the receiver system or the receiver adapter; and
a translation engine configured to translate a content of the communication from the first language to the second language and replace the content of the communication with the translated content in the second language.

12. The process integration system of claim 10,
wherein the sender adapter is configured to receive a second communication in a third language from a second sender system, the second communication in a fourth format of the second sender system,
wherein the integration engine is configured to convert the second communication into the second format of the process integration system, and to identify the receiver system from the second communication in the second format,
wherein the receiver adapter is configured to convert the second communication from the second format to the third format of the receiver system, and to send the second communication in the second language and in the third format to the receiver system, and
wherein the language converter module is configured to translate the second communication in the third format to the second language associated with the receiver system.

13. The process integration system of claim 10,
wherein the sender adapter is configured to identify a second receiver system from the communication in the second format,
wherein the receiver adapter is configured to convert the communication from the second format to a fourth format of the second receiver system, and send the communication in the fourth format and in a third language to the second receiver system, and
wherein the language converter module is configured to translate the communication in the fourth format to the third language associated with the second receiver system.

14. The process integration system of claim 13,
wherein the sender adapter is configured to receive a first message from a sender at the sender system, and
wherein the language converter module is configured to access the identified language of a recipient of the first message and generate a second message in the identified language of the recipient.

15. The process integration system of claim 10, wherein the process integration system interfaces between heterogeneous systems to provide a unified interface, the heterogeneous systems comprising the sender system and the receiver system.

16. The process integration system of claim 10, wherein the sender system or the receiver system comprises a file server, a mail server, or a database server, wherein the second format comprises an XML-based format.

17. The process integration system of claim 10,
wherein the sender adapter is configured to receive a second communication in a third language from the sender system, the second communication in the first format of the sender system,
wherein the sender adapter is configured to convert the second communication into the second format of the process integration system, and the integration engine is configured to identify the receiver system from the second communication in the second format,
wherein the receiver adapter is configured to convert the second communication from the second format to the third format of the receiver system, and send the second communication in the second language and in the third format to the receiver system,
wherein the language converter module is configured to translate the second communication in the third format to the second language associated with the receiver system.

18. The process integration system of claim 10,
wherein the sender adapter is configured to receive a second communication in the first language from the sender system, the second communication in the first format of the sender system;
wherein the sender adapter is configured to convert the second communication into the second format of the process integration system, and integration engine to identify the receiver system from the second communication in the second format,
wherein the receiver adapter is configured to convert the second communication from the second format to the third format of the receiver system, and to send the communication in the third format and in a third language to the receiver system,
wherein the language converter module is configured to translate the second communication in the third format to the third language associated with the receiver system.

19. A non-transitory machine-readable storage medium storing instructions which, when executed by at least one processor, performs operations comprising:
receiving a communication in a first language from a sender system, the communication in a first format of the sender system;
converting, using at least one processor of a machine, the communication into a second format of a process integration system, the process integration system configured to interface between the sender system and a receiver system;
identifying the receiver system from the communication in the second format;
converting the communication from the second format to a third format of the receiver system;
translating the communication in the third format to a second language associated with the receiver system; and
sending the communication in the third format and in the second language to the receiver system.

20. The non-transitory machine-readable storage medium of claim 19, wherein the operations further comprises:
determining the first language associated with the sender system;
determining the second language associated with the receiver system;
translating a content of the communication from the first language to the second language; and
replacing the content of the communication with the translated content in the second language.
